(19) United States
(12) Patent Application Publication
(10) Pub. No.: US 2025/0202103 A1
(43) Pub. Date: Jun. 19, 2025

(54) Methods and Devices for Adjusting the Pointing Direction of an Antenna

(71) Applicant: Telefonaktiebolaget LM Ericsson (publ), Stockholm (SE)

(72) Inventors: Niklas Jaldén, Enköping (SE); Anders Furuskär, Stockholm (SE); Peter Ökvist, Luleå (SE)

(21) Appl. No.: 18/838,474

(22) PCT Filed: Mar. 16, 2022
(86) PCT No.: PCT/SE2022/050251

§ 371 Date: Aug. 14, 2024

(51) Int. Cl. H01Q 3/02; H04B 7/06

(52) U.S. Cl. CPC H01Q 3/02; H04B 7/06952

(57) ABSTRACT

An improved method (300) for adjusting the pointing direction of an antenna, wherein the antenna is operable to generate a set of N beams, where N>2. In one embodiment, the method includes obtaining a first beam use data set associated with a first period of time, wherein, for each beam included in the set of N beams, the first beam use data set comprises a first beam quality value indicating a quality of the beam. The method also includes, based on the first beam use data set, determining whether or not to adjust a pointing direction of the antenna. The method further include, as a result of determining to adjust the pointing direction of the antenna, initiating an adjustment of the pointing direction of the antenna based on the first beam use data set.

### TECHNICAL FIELD

Disclosed are embodiments related to methods and devices for adjusting the pointing direction of an antenna.

### BACKGROUND

Fixed Wireless Access (FWA) is an efficient and scalable alternative to wired connections. For example, a fifth generation (5G) FWA device placed in a building (e.g., a home) can provide network access to users within the building by communicating with the users in the building using, e.g., Wi-Fi, and communicating with a base station of a radio access network (RAN) using 5G New Radio (NR). Accordingly, an FWA device is often used as an alternative to fiber installation in areas where fiber is not available or too costly.

Given that a FWA device typically serves a building and acts a cellular termination point for a multitude of users as well as, e.g., household big-screen streaming services such as Netflix, etc., it is expected that the data consumption for an FWA device link is significantly higher than that of a mobile wireless access device (a.k.a., mobile user equipment (UE)).

Because both the FWA device and the base station with which the FWA communicates are generally stationary, the dominating paths of the radio channel are quite constant, or at least not subject to node mobility. This allows for use of fixed, directional antennas not only at the base station, but also at the FWA device. If directed in the right way, a directional antenna amplifies the desired signal and attenuates interference, which in turn leads to improved performance, such as high end-user data rates, lower delays, better coverage and higher capacity, i.e. higher system utilization and better system efficiency.

Conventionally, directive antennas are often not constructed as a single large patch, but instead built with multiple smaller elements that allow control of relative phase (and sometimes amplitude) between elements, which in turn generates a narrow beam that can be pointed in different directions. Despite the ability to adapt the beam direction, the antenna is limited by the gain of each of the separate elements, and it is well-known that an antenna performs at its best when operating in directions close to boresight.

### SUMMARY

A typical base station (BS) is configured to cover a large area so as to cover a large number of potential user. Hence, optimization of the coverage area cannot target a single BS-UE link. Basically, the BS needs an antenna deployment that can work for any and all possible locations, which are often unknown form the network side.

In contrast, from the terminal (end user) side, the problem is in theory simpler as the wireless communication is primarily done towards one serving node (e.g., one base station), and in FWA device scenarios, this is even more so as the FWA device is typically not moving. Nevertheless, certain challenges presently exist.

For instance, it is not always straight-forward to align the antenna of an FWA device as the location of the serving base station is not always known, and, even if it were, there may not be line of sight to the BS and the most beneficial propagation directions are in general not known. Further, even if a good direction was found when the FWA device was initially installed and set up, changes in the environment, affecting the dominating propagation paths, may cause the original directions to be suboptimal.

Accordingly, in one aspect there is provided an improved method for adjusting the pointing direction of an antenna, wherein the antenna is operable to generate a set of N beams, where N>2. In one embodiment, the method includes obtaining a first beam use data set associated with a first period of time, wherein, for each beam included in the set of N beams, the first beam use data set comprises a first beam quality value indicating a quality of the beam. The method also includes, based on the first beam use data set, determining whether or not to adjust a pointing direction of the antenna. The method further includes, as a result of determining to adjust the pointing direction of the antenna, initiating an adjustment of the pointing direction of the antenna based on the first beam use data set.

In another aspect there is provided a computer program comprising instructions which when executed by processing circuitry of a device causes the device to perform the above described method. In another aspect there is provided a carrier containing the computer program, wherein the carrier is one of an electronic signal, an optical signal, a radio signal, or a computer readable storage medium.

In another aspect there is provided a device where the device is configured to perform the methods disclosed herein. In some embodiments, the device includes processing circuitry and a memory containing instructions executable by the processing circuitry, whereby the device is configured to perform the methods disclosed herein.

The embodiments are advantageous in that they provide improved performance for the end-user in terms of data rates, delay, and reliability, as well as better performance for the operator in terms of higher capacity (through lower resource consumption). Moreover, some embodiments ease of deployment of a FWA device for end user because, in some embodiments in which the FWA device has a motor for moving the antenna, the FWA device can automatically adjust its pointing direction.

### BRIEF DESCRIPTION OF THE DRAWINGS

The accompanying drawings, which are incorporated herein and form part of the specification, illustrate various embodiments.

FIG. 1 illustrates a communication system according to an embodiment.

FIG. 2A illustrates an example histogram.

FIG. 2B illustrates another example histogram.

FIG. 3 is a flowchart illustrating a process according to some embodiments.

FIG. 4 illustrates a UE according to some embodiments.

### DETAILED DESCRIPTION

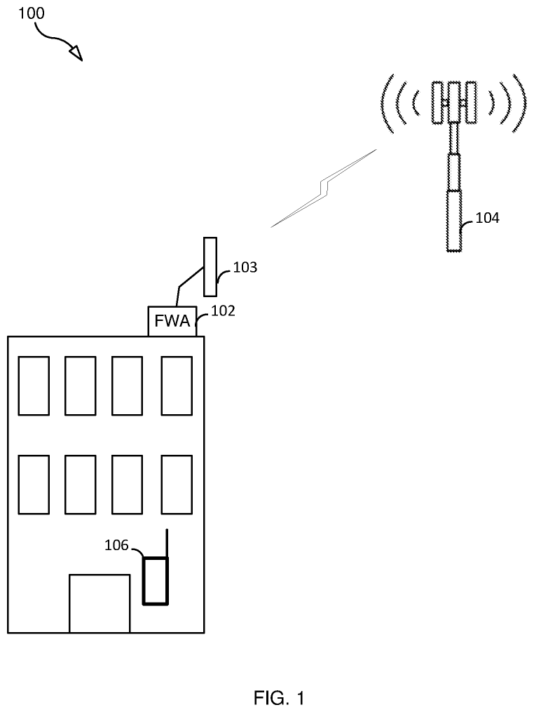

FIG. 1 illustrates a communication system 100 according to an example use case. In the example shown, communication system 100 includes a FWA device 102 having an antenna 103, and FWA device 102 provides network access to UEs (e.g., UE 106) by communicating with a base station 104 of a RAN. That is, FWA device 102 essentially functions like a relay or repeater by, for example, receiving data transmitted by UE 106 via a Wi-Fi link and forwarding the data to base station 106 via, for example, an NR link or 4G (Long Term Evolution (LTE)) link, etc., and vice-versa.

As described above, it is not always straight-forward to align antenna 103 of FWA device 102. Accordingly, in one embodiment, historical information of the beams (transmit (Tx) beams and/or receive (Rx) beams) used to communicate with BS 104 is used to adjust the pointing direction of antenna 103 for optimized performance. That is, for example, a process is performed for aligning antenna 103 with base station 104.

In one embodiment, FWA device 102 is equipped with an electromechanical device that can adjust antenna 103's pointing direction. This feature is not a requirement, but nevertheless allows for automatic readjustments. In embodiments in which FWA device 102 is not equipped with a motor, a notification can be sent to an end user to realign the antenna x-degrees in relation to current deployment.

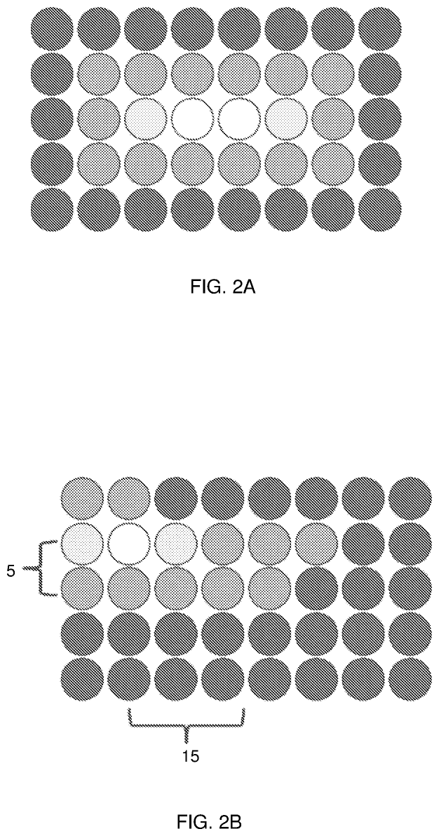

As stated in background, an antenna array performs at its best when operating around boresight. Hence, observing a histogram of used beams in a terminal (potentially weighted with the resulting link throughput) we would like to have a two-dimensional (2D) histogram like depicted in FIG. 2A, where each circle represents a beam and white indicates good performance (and/or how frequent given beam is used), and darker grey is less frequent use (lower performance).

In one embodiment, FWA device 102 keeps a log of the beams (analog or digital) that are used to communicate with BS 104. For example, FWA device 102 may be able to generate N different beams (e.g., 40 beams) and may periodically evaluate the beams and select the best beam, and the log file will indicate which beams were selected over a given time period. After the given period of time (can be minutes/hours/days) a histogram can be generated based on the logged information and the histogram can be assessed, an example of such a histogram is shown in FIG. 2B. From the figure it is seen that the center of mass in the histogram is misaligned by 5° in elevation and 15° in horizontal direction. Based on said angles, FWA 102 can determine a vertical/horizontal offset adjustment value and invoke the motor to realign antenna 102 correspondingly, or, if there is no motor, indicate the required adjustment to an end user, who can then manually adjust the pointing direction of antenna 103. FWA 102 resets the beam histogram data after realignment and resumes logging.

In one embodiment, the realignment of antenna 103 is done at fixed intervals (hourly/daily/weekly). In another embodiment, the antenna realignment occurs after a given number of transmissions/receptions have occurred (e.g., after a threshold amount of data has been collected). In another embodiment, the antenna realignment process occurs after a given number of transmissions/receptions have occurred (e.g., enough data has been collected) where a percentage of transmissions/receptions have a measure (e.g., signal strength/quality, user and/or link performance, etc.) above/below a predetermined threshold.

In some embodiments, the information logged may not only include the beam identifies (e.g., beam index) identifying the selected beams, but also information on link performance (when in active use), link signals strength, and/or quality. FWA device 102 may then aggregate statistics of beam-use histogram with additional information of associated link performance. Then, in the step of determining an offset readjustment value, the device may evaluate if the anticipated gain from moving the antenna is greater than a threshold, and, if not, may refrain from moving the antenna.

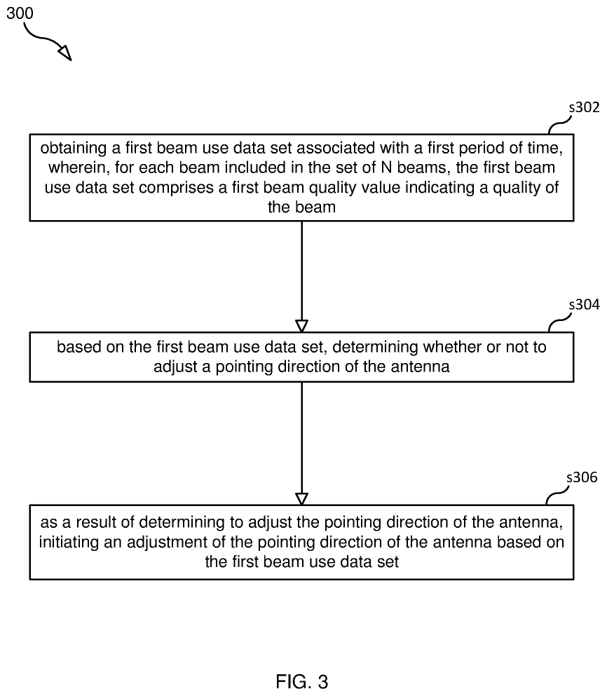

FIG. 3 is a flowchart illustrating a process 300, according to an embodiment, for adjusting the pointing direction of an antenna (e.g., antenna 103 of FWA device 102), wherein the antenna is operable to generate a set of N beams (e.g., N>2). Process 300 may be performed by FWA device 102 (or another device) and may begin in step s302.

Step s302 comprises obtaining a first beam use data set associated with a first period of time, wherein, for each beam included in the set of N beams, the first beam use data set comprises a first beam quality value indicating a quality of the beam.

Step s304 comprises, based on the first beam use data set, determining whether or not to adjust the pointing direction of the antenna.

Step s306 comprises, as a result of determining to adjust the pointing direction of the antenna, initiating an adjustment of the pointing direction of the antenna based on the first beam use data set.

Table 1 below provides an example of the type of information included in a beam use data set and the organization of this data. This data can be used to generate the histogram shown in FIG. 2B.

TABLE 1

| | | Pointing Direction |
|---|---|---|
| Beam ID | Quality Value | (x, y Offsets) |
| 1 | 6 | +10, +10 |
| 2 | 8 | +10, +5 |
| 3 | 6 | +10, 0 |
| 4 | 7 | +5, +10 |
| 5 | 8 | +5, +5 |
| 6 | 6 | +5, 0 |
| 7 | 7 | 0, +10 |
| 8 | 8 | 0, +5 |
| 9 | 6 | 0, 0 |
| . . . | . . . | . . . |
| 17 | 3 | −10, −5 |
| 18 | 3 | −10, −10 |

In one embodiment, the quality value for each beam is a scalar beam utilization value that specifies the utilization of the beam (e.g., number of times the beam was selected during a certain period of time or the amount of time that the beam was used during the certain period of time). In another embodiment, the quality value for each beam is a vector that includes the beam utilization value and an average performance metric (e.g., average throughput value). In another embodiment, the quality value for each beam is a value equal to: U×P, where U is the beam utilization value and P is the average of the performance metric. In this way, each beam utilization value is weighted with a corresponding performance metric. Accordingly, if two beams have the same beam utilization value (e.g., each one of the two beams was used 10 times within the period of time), then the beam with the higher average performance will have the higher quality value.

In some embodiments, the step of determining whether or not to adjust a pointing direction of the antenna comprises selecting at least a first beam from the set of N beams based on the first beam use data set, wherein the first beam use data set indicates that none of the unselected beams from the set of N beams has a quality greater than the quality of the selected beam. That is, a beam (or beams) associated with the highest quality value is chosen. Using table 1 as an example, beams 2, 5, and 8 are selected. As shown in Table 1, each beam has a pointing direction, which, in the example, shown, is represented by an x,y offset (e.g., elevation, azimuth angle offset) from the antenna boresight.

In some embodiments, the step of determining whether or not to adjust a pointing direction of the antenna further comprises i) obtaining, for each selected beam, the x,y offset values for the selected beam, ii) averaging the x,y offset values to produce an average x offset value and an average y offset value, and ii) using the average x,y offset values to determine whether to adjust the pointing direction. For example, in one embodiment, it is determined to adjust the pointing direction if either the average x offset value or the average y offset value is greater than a threshold value (Th) (e.g., Th=0).

In some embodiments, the step of initiating the adjustment of the pointing direction of the antenna based on the first beam use data set comprises initiating the adjustment of the pointing direction of the antenna based on the pointing direction of the selected beam. For example, assume that in the determining step a single beam was selected (e.g., beam 2 from table 1). In this example, beam 2 has x,y offset values of +10 and +5, respectively. Accordingly, given that beam 2 is the best beam and is offset from the boresight by +10 degrees horizontal and +5 degrees vertical, FWA device 102 will initiate moving the antenna 103 −10 degrees horizontal and −5 degrees vertical so that the best beam will now be aligned with the boresight. Hence, in some embodiments, initiating the adjustment of the pointing direction of the antenna based on the pointing direction of the selected beam comprises initiating the adjustment of the pointing direction of the antenna such that the antenna will point in the same direction as the selected beam.

As another example, assume that in the determining step all of the best beams were selected (i.e., beams 2, 5, and 8 from table 1). In this example, the x and y offset values are averaged to produce an average x offset value (i.e., (10+5+0)/3=+5) and an average y offset value (i.e., (5+5+5)/3=+5). Accordingly, given that, on average, the best beam is offset from the boresight by +5 degrees horizontal and +5 degrees vertical, FWA device 102 will initiate moving the antenna 103 −5 degrees horizontal and −5 degrees vertical so that the average best beam will now be aligned with the borsesight.

In some embodiment, process 300 also includes, after initiating the adjustment of the pointing direction of the antenna based on the first beam use data set, obtaining a second beam use data set associated with a second period of time that is subsequent to the first period of time, wherein, for each one of the beams included in the set of N beams, the second beam use data set comprises a second beam quality value indicating a quality of the beam; and, based on the second beam use data set, determining whether the antenna needs a further adjustment. In some embodiments, the process may further include, as a result of determining that the antenna needs a further adjustment, initiating the adjustment of the pointing direction of the antenna based on the second beam use data set.

In some embodiments, for each one of the beams included in the set of N beams, the beam quality value in the first beam use data set specifies a beam utilization for the beam (e.g., the total number of times the beam was used within the first period of time or the percentage amount of time the beam was used within the first period of time).

In some embodiments, the set of N beams comprises a first beam and a second beam, and the process further comprises generating the first beam use data set, wherein generating the first beam use data set comprises calculating a first beam quality value for the first beam and calculating a first beam quality value for the second beam. In some embodiments, calculating the first beam quality value for the first beam comprises calculating: qv+w, where qv is a stored quality value associated with the first beam and w is a weight value that depends on a link throughput measured while the first beam was being used to transmit or receive data. In other embodiments, calculating the first beam quality value for the first beam comprises calculating: U×P, where U is a beam utilization value for the beam and P is a performance metric (e.g. average throughput).

In some embodiments, initiating the adjustment of the pointing direction of the antenna comprises sending a control signal to a motor configured to move the antenna.

In some embodiments, initiating the adjustment of the pointing direction of the antenna comprises indicating to an end user that the antenna needs an adjustment (e.g., providing to the end user a notification notifying the end user that the antenna needs an adjustment).

Process 300 is suitable for any fixed link pairs, and could hence be deployed not only for a link between an FWA device and a ground-based base station, but also for micro links (backhauls), relay or repeater nodes, satellite communication for geo-stationary satellites, etc. Accordingly, the antenna may be a component of any UE (e.g., any FWA device, mobile phone, sensor, etc.). That is, process 300 may be performed by an UE that is generally stationary, has a moveable antenna, and is served by a generally stationary serving node, such as, for example, a ground-based BS.

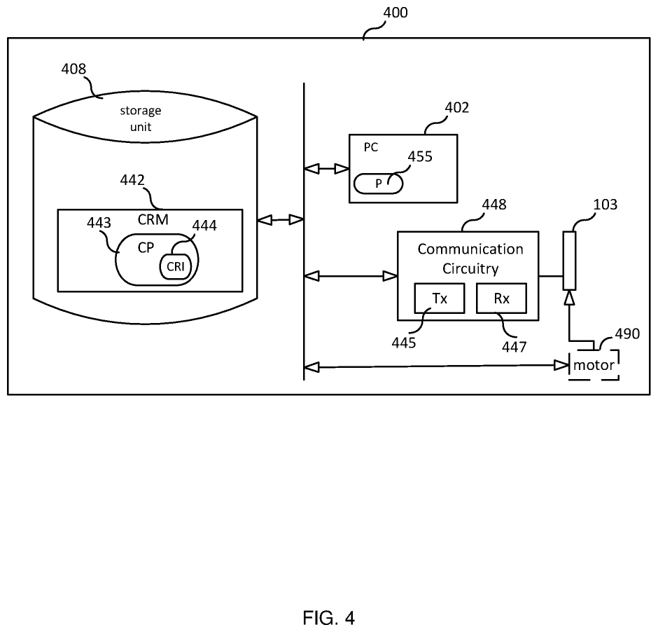

FIG. 4 is a block diagram of a representative UE 400, according to some embodiments, for performing the methods disclosed herein (i.e., UE 400 may function as, for example, FWA device 102). As shown in FIG. 4, UE 400 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., UE 400 may be a distributed computing apparatus where some function are performed in one location and other functions performed in another location): communication circuitry 448, which is coupled to antenna 103 and which comprises a transmitter (Tx) 445 and a receiver (Rx) 447 for enabling UE 102 to transmit data and receive data (e.g., wirelessly transmit/receive data); and a local storage unit (a.k.a., “data storage system”) 408, which may include one or more non-volatile storage devices and/or one or more volatile storage devices. Additionally, as illustrated in FIG. 4, UE 400 may also include a motor 490 for moving antenna 103, and, thereby, adjusting the pointing direction of antenna 103.

In embodiments where PC 402 includes a programmable processor, a computer readable medium (CRM) 442 may be provided and may store a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes UE 400 to perform steps described herein (e.g., steps described herein with reference to the flow charts). In other embodiments, UE 400 may be configured to perform steps described herein without the need for code. That is, for example, PC 402 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1.-16. (canceled)

17. A method performed by a device for adjusting a pointing direction of an antenna, wherein the antenna is operable to generate a set of N beams, where N>2, the method comprising:
obtaining a first beam use data set associated with a first period of time, wherein, for each beam in the set of N beams, the first beam use data set comprises a first beam quality value indicating a quality of the beam;
based on the first beam use data set, determining whether to adjust a pointing direction of the antenna; and
as a result of determining to adjust the pointing direction of the antenna, initiating an adjustment of the pointing direction of the antenna based on the first beam use data set.

18. The method of claim 17, wherein
determining whether to adjust a pointing direction of the antenna comprises selecting at least a first beam from the set of N beams based on the first beam use data set, wherein the first beam use data set indicates that none of the unselected beams from the set of N beams has a quality greater than the quality of the selected first beam;
the selected first beam has a pointing direction; and
initiating the adjustment of the pointing direction of the antenna is based on the pointing direction of the selected first beam.

19. The method of claim 18, wherein the adjustment of the pointing direction of the antenna is initiated such that the antenna will point in the same direction as the selected first beam.

20. The method of claim 17, further comprising:
after initiating the adjustment of the pointing direction of the antenna based on the first beam use data set, obtaining a second beam use data set associated with a second period of time that is subsequent to the first period of time, wherein, for each beam in the set of N beams, the second beam use data set comprises a second beam quality value indicating a quality of the beam; and
based on the second beam use data set, determining whether the antenna needs a further adjustment.

21. The method of claim 20, further comprising, as a result of determining that the antenna needs a further adjustment, initiating the further adjustment of the pointing direction of the antenna based on the second beam use data set.

22. The method of claim 17, wherein for each beam in the set of N beams, the beam quality value in the first beam use data set specifies the total number of times the beam was used within the first period of time.

23. The method of claim 17, wherein:
the set of N beams comprises a first beam and a second beam; and
the method further comprises generating the first beam use data set based on calculating a first beam quality value for the first beam and calculating a first beam quality value for the second beam.

24. The method of claim 23, wherein the first beam quality value for the first beam is calculated according to qv+w, wherein qv is a stored quality value associated with the first beam and w is a weight value that depends on a link throughput measured while the first beam was being used to transmit or receive data.

25. The method of claim 17, wherein initiating the adjustment of the pointing direction of the antenna comprises one of the following:
sending a control signal to a motor configured to move the antenna; or
indicating to an end user that the antenna needs an adjustment.

26. The method of claim 17, wherein the device is a user equipment (UE) and the antenna is a component of the UE.

27. A non-transitory, computer-readable medium storing a computer program comprising instructions that, when executed by processing circuitry of a device, cause the device to perform the method of claim 17.

28. A device comprising:
processing circuitry operably coupled to an antenna that is operable to generate a set of N beams, where N>2; and
a memory containing instructions executable by the processing circuitry, wherein
execution of the instructions by the processing circuitry configures the device to:
obtain a first beam use data set associated with a first period of time, wherein, for each beam included in the set of N beams, the first beam use data set comprises a first beam quality value indicating a quality of the beam;
based on the first beam use data set, determine whether to adjust a pointing direction of the antenna; and
as a result of a determination to adjust the pointing direction of the antenna, initiate an adjustment of the pointing direction of the antenna based on the first beam use data set.

29. The device of claim 28, wherein:
execution of the instructions by the processing circuitry configures the device to determine whether to adjust a pointing direction of the antenna based on selecting at least a first beam from the set of N beams based on the first beam use data set, wherein the first beam use data set indicates that none of the unselected beams from the set of N beams has a quality greater than the quality of the selected first beam;
the selected first beam has a pointing direction; and
execution of the instructions by the processing circuitry configures the device to initiate the adjustment of the pointing direction of the antenna based on the pointing direction of the selected first beam.

30. The device of claim 29, wherein execution of the instructions by the processing circuitry configures the device to initiate the adjustment of the pointing direction of the antenna such that the antenna will point in the same direction as the selected first beam.

31. The device of claim 28, wherein execution of the instructions by the processing circuitry further configures the device to:
after initiation of the adjustment of the pointing direction of the antenna based on the first beam use data set, obtain a second beam use data set associated with a second period of time that is subsequent to the first period of time, wherein, for each beam in the set of N beams, the second beam use data set comprises a second beam quality value indicating a quality of the beam; and
based on the second beam use data set, determine whether the antenna needs a further adjustment.

32. The device of claim 31, wherein execution of the instructions by the processing circuitry further configures the device to, as a result of a determination that the antenna needs a further adjustment, initiate the further adjustment of the pointing direction of the antenna based on the second beam use data set.

33. The device of claim 28, wherein for each beam in the set of N beams, the beam quality value in the first beam use data set specifies the total number of times the beam was used within the first period of time.

34. The device of claim 28, wherein:
the set of N beams comprises a first beam and a second beam; and
execution of the instructions by the processing circuitry further configures the device to generate the first beam use data set based on calculating a first beam quality value for the first beam and calculating a first beam quality value for the second beam.

35. The device of claim 34, wherein the first beam quality value for the first beam is calculated according to qv+w, wherein qv is a stored quality value associated with the first beam and w is a weight value that depends on a link throughput measured while the first beam was being used to transmit or receive data.

36. The device of claim 28, wherein execution of the instructions by the processing circuitry configures the device to initiate the adjustment of the pointing direction of the antenna based on one of the following:
sending a control signal to a motor configured to move the antenna; or
indicating to an end user that the antenna needs an adjustment.
